(19) United States
(12) Patent Application Publication
(10) Pub. No.: US 2015/0379656 A1
(43) Pub. Date: Dec. 31, 2015

(54) METHOD FOR MONITORING THE USE OF CONTROLLED SUBSTANCES

(71) Applicants: Larry B. Rothstein, Gahanna, OH (US); Larry R. Petrozzi, JR., New Albany, OH (US); Michelle B. Rothstein, Gahanna, OH (US)

(72) Inventors: Larry B. Rothstein, Gahanna, OH (US); Larry R. Petrozzi, JR., New Albany, OH (US); Michelle B. Rothstein, Gahanna, OH (US)

(21) Appl. No.: 14/314,690

(22) Filed: Jun. 25, 2014

(51) Int. Cl. G06Q 50/26; G06F 19/00; G06Q 10/00

(52) U.S. Cl. CPC G06Q 50/265; G06Q 10/00; G06F 19/34

(57) ABSTRACT

A method for monitoring use of controlled substances by one or more test subjects includes the steps of: entering contact data for a test subject into a monitoring program interacting with appropriate communication hardware to contact the test subject; the said step of entering, the monitoring program thereafter executing the step of: scheduling a random date for a drug test or drug usage test or both for the test subject; the monitoring program thereafter executing the step of attempting to contact the test subject and if successful contact is made, executing the step of advising the test subject as to the random date and, if successful contact is not made, executing the step of recording a failed contact entry and associating the failed contact entry with the test subject.

### FIELD OF THE INVENTION

The present invention generally relates to a method for monitoring the use of controlled substances. The method will be useful for monitoring the abuse of controlled substances and treating the monitored individuals showing signs of abuse of controlled substances. The method will also be useful for assisting those that administer controlled substances in monitoring drug use and/or abuse by those whom they prescribe controlled substances.

### BACKGROUND OF THE INVENTION

Prescription drug abuse has reached epidemic proportions in the United States, as it is now the fastest growing drug problem in the country. The extent of the problem, and the cost to society, has been well documented in medical literature, reports from governmental agencies and the media. Most states have established Prescription Monitoring Programs to provide physicians, pharmacists and law enforcement information to curb “doctor shopping”, wherein a patient clandestinely obtains care from multiple doctors in an effort to obtain more prescription drugs than would be obtain from on one doctor. In addition, there are multiple programs providing education and resources for all stakeholders. Unfortunately, there are no efforts to assist those that prescribe addictive drugs with the critical, yet labor intensive, daily tasks necessary to monitor proper drug use by each and every patient either requiring such controlled substances or for whom they are being considered. Nevertheless, those that prescribe addictive drugs still have the responsibility to adhere to expanding requirements, and face potentially severe penalties for failing to do so.

Historically, physicians are taught to diagnose, order tests and develop a treatment plan in a comprehensive manner. Many physicians are trained in diagnosing pain as it relates to their particular field, and some of the training may include diagnosing and treating some behavioral component of the patient's care. Unfortunately, except for the relatively new specialty of addiction medicine, physicians receive very little training about substance misuse or addiction. Therefore, other than learning the laws concerning prescribing controlled substances, physicians are generally ill-prepared to deal with patients that develop aberrant drug related behavior or substance use disorders. They are even less prepared to manage patients having a history of, or active, alcoholism or substance use disorder. Despite the potential lack of formal training, physicians are nevertheless held to a high standard of care when prescribing controlled substances.

Federal, state and local governments and law enforcement attempt to combat the problem with new legislation and its enforcement, while professional societies periodically update guidelines and enact rules to guide prescribers. State medical boards are central to these efforts and are mandated to hold physicians accountable and impose penalties for substandard care. Therefore, physicians are required to elevate their standard of care, perform additional tests and review more data, all in an environment which is already increasing their workload with diminishing resources. This ultimately affects the public because it decreases the availability of their medications if their doctors choose to stop prescribing controlled substances to avoid increased scrutiny and risk. In addition, if their doctor does continue to prescribe, and fails to meet the updated standards of care and loses their license, the patient is then forced to find another doctor who will prescribe their medications.

To truly prevent prescription drug abuse, prescribers must implement policies and procedures outlined in the current state law, medical board rules and nationally accepted guidelines. It is imperative that prescribers have resources available to follow the steps necessary to evaluate and monitor patients for aberrant drug related behavior, objectively modify the treatment plan accordingly and document their findings. Furthermore, physician's compliance needs to be evaluated and hopefully addressed, prior to investigations and disciplinary action. There is a need in the art for a method for monitoring use of controlled substances by one or more patients to assist the prescriber in evaluating and monitoring aberrant drug related behavior. There is further need in the art for such a method that also provides documentation of the prescriber's efforts so as to help insulate the prescriber from accusations of failing to properly monitor the patient and prescribe drugs to the patient.

### SUMMARY OF THE INVENTION

In a first embodiment, the present invention provides a computer implemented method for monitoring the use of controlled substances by one or more test subjects. The present invention comprises the steps of entering contact data for a test subject into a monitoring program, where the monitoring program interacts with appropriate communication hardware such that the monitoring program is able to contact the test subject through the communication hardware using the contact data. After the step of entering, the monitoring program thereafter executes the steps of scheduling a random date for a drug test or drug usage test or both for the test subject, wherein the monitoring program thereafter executes the step of attempting to contact the test subject through the communication hardware using the contact data. If successful contact is made, the monitoring program executes the step of advising the test subject as to the random date the test subject is required to submit to a drug test or a drug usage test or both relating to the use of a controlled substance. If successful contact is not made, the step of recording a failed contact entry and associating the failed contact entry with the test subject is executed.

In a second embodiment, the present invention provides a computer implemented method as in the first embodiment, wherein the drug test is selected from urine, saliva, hair, blood and sweat tests.

In a third embodiment, the present invention provides a computer implemented method as in either the first or second embodiment, wherein the drug test is a urine test.

In a fourth embodiment, the present invention provides a computer implemented method as in any of the first through third embodiments, wherein the drug usage test is a test monitoring the remaining quantity of a prescribed substance.

In a fifth embodiment, the present invention provides a computer implemented method as in any of the first through fourth embodiments, wherein the drug usage test is a pill count.

In a sixth embodiment, the present invention provides a computer implemented method as in any of the first through fifth embodiments, wherein the controlled substance is selected from opiates, amphetamines, marijuana, cocaine, phencyclidine (PCP), cannabinoids, barbiturates, hydrocodones, methaqualones and benzodiazepines.

In a seventh embodiment, the present invention provides a computer implemented method as in any of the first through sixth embodiments, wherein the test subject is prescribed a controlled substance.

In an eighth embodiment, the present invention provides a computer implemented method as in any of the first through seventh embodiments, wherein the controlled substance is selected from opiates, sedatives, hypnotics and stimulants.

In a ninth embodiment, the present invention provides a computer implemented method as in any of the first through eighth embodiments, wherein the method further comprises the steps of obtaining consent of the test subject to (a) accept and abide by the scheduling of random dates for a drug test or drug usage test and to (b) submit to the drug test or drug usage monitoring when advised in the step of advising the test subject.

In a tenth embodiment, the present invention provides a computer implemented method as in any of the first through ninth embodiments, wherein, if successful contact is made in the step of attempting to contact the test subject, the monitoring program thereafter executes the step of recording a successful contact entry and associating it with the test subject.

In an eleventh embodiment, the present invention provides a computer implemented method as in any of the first through tenth embodiments, wherein, if successful contact is made in the step of attempting to contact the test subject, the monitoring program generates a test results date for monitoring the results of the test scheduled in the step of scheduling.

In a twelfth embodiment, the present invention provides a computer implemented method as in any of the first through eleventh embodiments, wherein a failed contact entry results from the monitoring program that receives notice of an event selected from a disconnected phone, an invalid number and a blocked call.

In a thirteenth embodiment, the present invention provides a computer implemented method as in any of the first through twelfth embodiments, wherein the method further comprises the step of recording a failed attendance entry in the monitoring program and associating it with the test subject if the test subject does not show at the test scheduled in the step of scheduling.

In a fourteenth embodiment, the present invention provides a computer implemented method as in any of the first through thirteenth embodiments, wherein the method further comprises the step of performing the drug test or drug usage test or both on the test subject on the random date and recording the test results entry in the monitoring program and associating the test results entry with the test subject.

In a fifteenth embodiment, the present invention provides a computer implemented method as in any of the first through fourteenth embodiments, wherein the step of performing is performed by testing software or testing hardware or both, and the step of recording a test results entry is performed automatically by the testing software or testing software or both communicating with the monitoring software.

In a sixteenth embodiment, the present invention provides a computer implemented method as in any of the first through fifteenth embodiments, wherein the step of performing is performed by a test-giver, and the step of recording a test results entry includes the test-giver communicating the test results to the monitoring program, which records the test results.

In a seventeenth embodiment, the present invention provides a computer implemented method as in any of the first through sixteenth embodiments, wherein the monitoring program further performs the step of generating a monitoring report providing compliance data associated with the test subject. The compliance data is selected from one or more of the failed contact entry, successful contact entry, failed attendance entry, and test results entry.

In an eighteenth embodiment, the present invention provides a computer implemented method as in any of the first through seventeenth embodiments, wherein the monitoring software monitors multiple test subjects through the steps of entering contact data, scheduling a random date, attempting to contact, advising the test subject and recording the test results entry.

In a nineteenth embodiment, the present invention provides a computer implemented method as in any of the first through eighteenth embodiments, wherein the monitoring program further performs the step of generating a results list providing compliance data associated with the test subject, the compliance data being selected from one or more of the failed contact entry, successful contact entry, failed attendance entry, and test results entry, and the results list is accessible to quickly show the compliance data.

In a twentieth embodiment, the present invention provides a computer implemented method as in any of the first through nineteenth embodiments, wherein the results list can be accessed via computer and the results list is displayed on a monitor of the computer.

In a twenty-first embodiment, the present invention provides a computer implemented method as in any of the first through twentieth embodiments, wherein the results list provides conspicuous indicia indicating the compliance data.

In a twenty-second embodiment, the present invention provides a computer implemented method as in any of the first through twenty-first embodiments, wherein the conspicuous indicia is a red flag if the compliance data includes one or more of a failed contact entry, a failed attendance entry or a test results entry indicated failure of a test.

In a twenty-third embodiment, the present invention provides a computer implemented method as in any of the first through twenty-second embodiments, wherein the method further comprises the steps of establishing a results overseer that is provided with access to the results list, and wherein the results overseer identifies at-risk test subjects based on results of drug tests or drug usage tests.

In a twenty-fourth embodiment, the present invention provides a computer implemented method as in any of the first through twenty-third embodiments, wherein the results overseer directly or indirectly refers at-risk test subjects to counseling.

In a twenty-fifth embodiment, the present invention provides a computer implemented method as in any of the first through twenty-fourth embodiments, wherein the method further comprises the steps of establishing a test subject enroller that performs the steps of enrolling test subjects and educating test subjects on the method for monitoring use of controlled substances.

In a twenty-sixth embodiment, the present invention provides a computer implemented method as in any of the first through twenty-fifth embodiments, wherein the method further comprises the steps of establishing a test subject screener, which performs the step of screening test subjects and identifying a risk level of substance abuse for each test subject screened.

In a twenty-seventh embodiment, the present invention provides a computer implemented method as in any of the first through twenty-sixth embodiments, wherein the method further comprises the steps of establishing a protocol manager that performs the step of establishing a protocol for test subjects, where the protocol is entered into the monitoring program to control the type or types of tests scheduled in the step of scheduling, and thus also establishes the type or types of tests performed in the step of performing, and for which results are recorded and associated in the steps of recording a test results entry and associating the test results entry.

In a twenty-eighth embodiment, the present invention provides a computer implemented method as in any of the first through twenty-seventh embodiments, wherein the results overseer, the test subject enroller, the test subject screener and the protocol manager are a single individual.

In a twenty-ninth embodiment, the present invention provides a computer implemented method as in any of the first through twenty-eighth embodiments, wherein the monitoring software through associated hardware further performs the step of generating a monitoring report providing compliance data associated with the test subject. The compliance data is selected from one or more of the failed contact entry, successful contact entry, failed attendance entry and test results entry, wherein test subjects are prescribed a prescription for controlled substances by a physician and the physician receives the monitoring reports from the step of generating a monitoring report.

In a thirtieth embodiment, the present invention provides a computer implemented method as in any of the first through twenty-ninth embodiments, wherein the method further comprises the step of the physician maintaining or discontinuing the prescription for a given test subject based at least in part on the monitoring report.

In a thirty-first embodiment, the present invention provides a computer implemented method as in any of the first through thirtieth embodiments, wherein a prescription is maintained in the step of the physician maintaining or discontinuing the prescription, and the monitoring program is therefore caused to repeat the steps of scheduling a random date, attempting to contact the test subject, and advising the test subject as to the random date.

### BRIEF DESCRIPTION OF THE DRAWINGS

FIG. 1 provides a flow chart of some of the process steps of the computer implemented method of this invention employing a monitoring program.

FIG. 2 provides a flow chart showing various data entries into the monitoring program and the generation of a monitoring report and results list.

FIG. 3 provides a flow chart showing some individuals that might interact with a test subject and the assessments that may be made for entry into the monitoring program.

### DETAILED DESCRIPTION OF ILLUSTRATIVE EMBODIMENTS

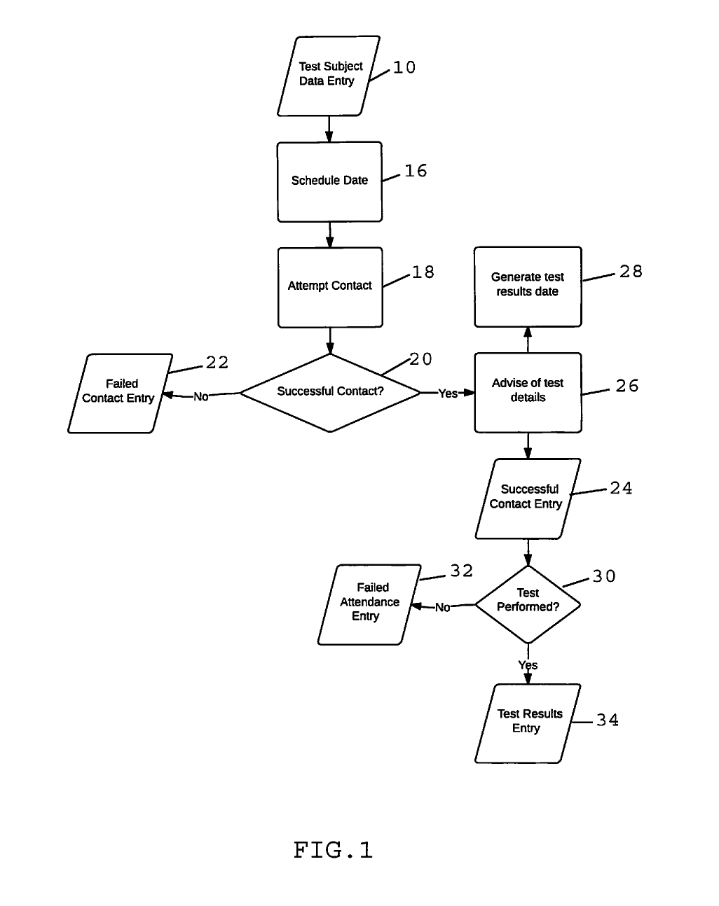

FIG. 1 provides a flow chart showing some of the core method steps of this invention. Herein, those being monitored are labeled as “test subjects” (or test subject, when singular) because they are subject to testing. In many instances the “test subjects” will be patients of a physician or another that prescribes controlled substances. However, the term “test subjects” provides a broader context. The present method is computer implemented, with “computer” being understood as any device for storing and processing data according to instructions given it in a program. The present computer implemented method includes appropriate hardware and/or software appropriate to carry out the method steps, which are explained by way of flow charts. Software may be on local computers or on servers (cloud computing).

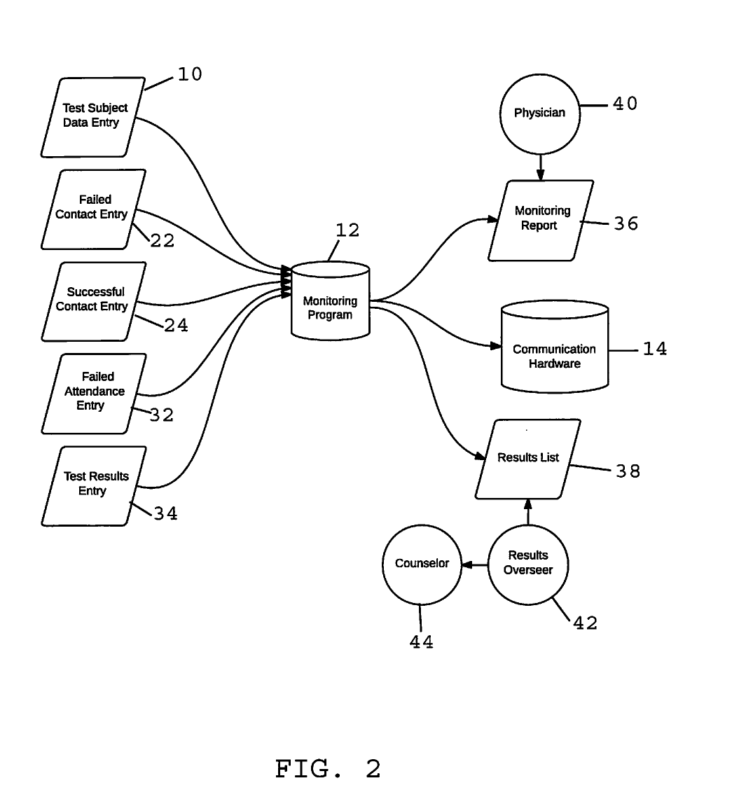

The core concepts of the computer implemented method are shown in FIG. 1. To begin, there must be at least one test subject, so test subject data must be entered into a monitoring program. A test subject data entry step 10 is first completed. In some embodiments, the test subject data includes contact data for a test subject. As seen in FIG. 2, the monitoring program 12 communicates with communication hardware 14. The monitoring program 12 is able to contact the test subjects through the communication hardware 14 using the contact data. The communication hardware can be any form of telecommunication, which is understood as communication at a distance by technological means. In particular embodiments, the telecommunication provided by the communication hardware 14 is selected from telephone communication (which is to include land line and mobile communications) and computer network communication (which is to include communication over the internet, including messaging, e-mail, text and twitter). Other means later created and adopted by individuals for communicating will be suitable as well, as it is often quite simple to adopt and adapt new forms of communication to replace old ones. The contact data is therefore data sufficient to allow the communication hardware 14 to telecommunicate with a test subject. In some embodiments, paralleling those exemplified above, the contact data is selected from land line and cell phone numbers, e-mail addresses, instant messaging contact name, and contact information for any number of social media websites or services.

After the test subject data entry step 10 the monitoring program 12 executes schedule date step 16, which involves scheduling a random date for a drug test or a drug usage test or both for the test subject. In some embodiments, both a drug test and drug usage test are scheduled for a single test subject.

Herein, a drug test is a test that monitors one or more drugs in a test subject's system. In some embodiments, the drug test is selected from urine, saliva, hair, blood and sweat tests. In some embodiments, the drug test is a urine test. The type of drug test can be a prescribed controlled substance or an illegal controlled substance, with the understanding that the line between the two does change in accordance with location and changing legislation and the like. In some embodiments, the test subject data entry step 10 includes the names of all substances that will be looked for in the drug test. In some embodiments, the monitoring program 12 maintains a calendar for the test-giver to manage the provision of test to one or more test subjects. In some embodiments, the test-giver for a drug test is a laboratory drug test facility. In some embodiments, the test-giver is an outside lab that is simply contacted by individuals interacting with the present computer-implemented system to determine if the lab can accept a test subject at the scheduled random date.

As used herein, a drug usage test is a test that monitors the quantity of a controlled substance that the test subject brings to the test location. The amount brought is compared to the amount that should be present given the amount prescribed, the prescribed dosage per day, and the number of days since the prescription was filled. A surplus could indicate an individual is not taking enough of the prescribed drug or that the amount needed for that particular test subject is less than prescribed. A deficit could represent that the test subject is taking the drug in excess of that which was prescribed or taking the drug in a manner consistent with substance use disorder, chemical dependency, addiction, or aberrant drug related behavior. This may work for solid or liquid form or syringe administered drugs. In some embodiments, the drug usage test is a pill count based on a prescribed number of pills of a controlled substance. That is, a test subject that has been prescribed a particular amount of a controlled substance when participating in a drug usage test, will submit to a test-giver the remaining amount of the prescribed controlled substance so that the test-giver may determine how much of the drug has been used since the prescription was issued. In some embodiments, the monitoring program 12 maintains a calendar for the test-giver to manage the provision of test to one or more test subjects. In some embodiments, the test-giver is a pharmacist. This test will apply to prescribed substances, as a test subject is not likely to submit to a drug usage test relating to an illegal drug. In some embodiments, the test subject data entry step 10 includes one or more of the following: the name of prescribed substance, the amount prescribed, the prescribed dosage per day, and the number of days since the prescription was filled.

Virtually any controlled substance presently existing or hereafter invented can be monitored. In some embodiments, the controlled substance is selected from opiates, amphetamines, marijuana, cocaine, phencyclidine (PCP), cannabinoids, barbiturates, hydrocodones, methaqualones and benzodiazepines. In some embodiments, the controlled substance is selected from opiates, sedatives, hypnotics and stimulants. In some embodiments, the controlled substance is selected from Tramadol™.

With continued reference to FIG. 1, after the schedule date step 16, the monitoring program 12 thereafter executes an attempt to contact step 18 wherein the monitoring program attempts to contact the test subject through the communication hardware 14, using the contact data. In some embodiments, the monitoring program includes one or more of an automated calling system, an automated e-mailing system, an automated instant messaging system, and automated social media contact systems. In some embodiments, the monitoring program includes an automated calling system calling a landline or mobile number as established in the contact data referenced above.

At successful contact decision 20, the monitoring program 12 records either a failed contact entry 22 or a successful contact entry 24 and associates the failed contact entry 22 or successful contact entry 24 (as the case may be) with the test subject. If successful contact is made, the test subject is advised of test details, as at step 26. In some embodiments, step 26 includes advising the test subject as to the random date and time the test subject is required to submit to a drug test or a drug usage test or both. In some embodiments, step 26 includes informing the test subject of one or more of the following: the day of the test, the type of test, the location of the test, the time window to comply with the test, and who to contact with questions. In some embodiments, the monitoring program records one or more of report of all scheduled calls, the successful completion of the calls, whether a call was answered by a live person or voice mail, whether there is a busy signal, whether a call is not completed due to disconnected or invalid numbers or blocked numbers. In some embodiments, a call is considered to be successful when the call reaches a live person or a voice message is left. In some embodiments, the monitoring program continues to attempt to contact the test subject until a successful contact is made. In some embodiments, the monitoring program continues to attempt to contact the test subject upon a failed contact, but after a set number of attempts, enters a failed contact entry 22.

In some embodiments, if successful contact is made in the attempt contact step 18, the monitoring program 12 thereafter executes the step of recording a successful contact entry and associating it with the test subject. In some embodiments if successful contact is made in the attempt contact step 18, the monitoring program 12 generates a test results date, as at step 28 to monitor the results of the test scheduled in the schedule date step 16, that is, the monitoring program 12 generates a date by which the monitoring program 12 expects to have received a test results entry. If the test results entry is not received, the monitoring program 12 can provide notice to appropriate individuals, not limited to the results overseer, the test subject enroller, the test subject screener, and the protocol manager mentioned herein below.

In some embodiments, recording of a failed contact entry 22 results from the monitoring program 12 receiving communication indicating any one of a disconnected phone, an invalid number or blocked call. In this way, a test subject cannot claim that a disconnected phone, or fact that he has an invalid number or otherwise has the call blocked has caused him or her to fail to be contacted by the monitoring program 12. Although there may be instances where a test subject's phone is actually disconnected or, due to circumstances, the number became invalid without an intent to avoid the attempted contact by the monitoring program 12, in some embodiments, these occurrences can lead to a failed contact entry 22. These step are taken to prevent test subjects from easily avoiding the obligations implicated in the present method.

After a successful contact of the test subject, the time and date arrives for the drug test or drug usage test and the test is performed, if the test subject shows up for the testing. Thus, at test performed decision 30 it is established whether the test subject actually attends the drug test and/or the drug usage test. If the test subject does not appear for the test, an appropriate entry is made into the monitoring program 12, and the monitoring program 12 records a failed attendance entry, as at failed attendance entry 32. This failed attendance is associated with the test subject. If the test subject appears and the test is performed, the test results, which may be fail, pass or inconclusive are entered in the monitoring program 12, as at test results entry 34.

In some embodiments, the test is performed by testing computers with appropriate hardware and/or software to communicate the test results to the monitoring program 12 through appropriate communication hardware. In other embodiments, the test is performed by a test-giver, and the test-giver communicates the results to the monitoring program 12, which records the test results entry 34. The term test-giver is to be understood as not being limited to the particular individual or individuals that oversee the drug test and/or drug usage test. It will be appreciate that the test-giver can be a test organization with some individuals performing test functions and others communicating results.

Although the present invention could be employed to monitor a single test subject, in some embodiments, the monitoring program 12 monitor multiple test subjects through the steps of entering contact data (test subject data entry 10), scheduling a random date (schedule date step 16), attempting to contact the test subject (attempt contact step 18), advising the test subject (advise of test results step 26) and recording the test results (test results entry step 34).

With reference to FIG. 2, it can be seen that the test subject data entry 10, the failed contact entry 22, the successful contact entry 24, the failed attendance entry 32 and test results entry 34 are entered into and/or recorded by the monitoring program 12. In some embodiments, only one or more of the foregoing entries are made. In some embodiments, the monitoring program further performs the step of generating a monitoring report 36 and/or results list 38.

In some embodiments, the monitoring program 12 generates a monitoring report 36 that provides compliance data associated with the test subject, the compliance data being selected from one or more of the failed contact entry 22, the successful contact entry 24, the failed attendance entry 32 and test results entry 34. The monitoring report 36 is intended to be a formal report by which multiple test subjects can be viewed so that the compliance data can be reviewed and the actions of each test subject analyzed and acted upon if desired. In some embodiments, the monitoring report provides conspicuous indicia indicating the compliance data. The conspicuous indicia would indicate positive or negative results (successes or failures) of the various data entered. For example, a failed contact entry, failed attendance entry or failed drug test or drug usage test would result in conspicuous indicia being presented near a test subject's identifying information in the monitoring report. This could be a red flag or other color codes or symbols. Each failure could have its own symbol or any failure could have the same symbol or color inasmuch as it is important that the monitoring report quickly identify those individuals that may have substance abuse issues. In some embodiments, the monitoring report is accessed via a computer with the monitoring report displayed on a monitor. In some embodiments, the monitoring report may be printable or otherwise transferable to hard copy. In some embodiments, wherein test subjects are prescribed a prescription for controlled substances by a physician 40, the physician 40 accesses or receives the monitoring reports from the step of generating a monitoring report 36. The physician 40 may access or receive the reports through any hard copy or telecommunication method.

In some embodiments, the monitoring program 12 performs the step of generating a results list 38 that provides compliance data associated with the test subject, the compliance data being selected from one or more of the failed contacts entry, successful contact entry, failed attendance entry and test results entry. The results list 38 is intended to be a list by which multiple test subjects can be viewed at one time so that the compliance data can be quickly viewed and the actions of each test subject quickly analyzed. In some embodiments, the results list provides conspicuous indicia indicating the compliance data. The conspicuous indicia would indicate positive or negative results (successes or failures) of the various data entered. For example, a failed contact entry, failed attendance entry or failed drug test or drug usage test would result in conspicuous indicia being presented near a test subject's identifying information in the results list. This could be a red flag or other color codes or symbols. Each failure could have its own symbol or any failure could have the same symbol or color inasmuch as it is important that the results list quickly identify those individuals that may have substance abuse issues. In some embodiments, the results list is accessed via a computer with the results list displayed on a monitor. In some embodiments, the results list may be printable or otherwise transferable to hard copy.

In some embodiments, a results overseer 42 is established and receives or has access to the results list from the step of generating a results list 38. The results overseer 42 may access or receive the reports through any hard copy or telecommunication method. The results overseer 42 identifies at-risk test subjects based on results of drug tests and drug usage tests. In some embodiments, the results overseer 42 directly or indirectly refers test subjects to counseling with a counselor 44.

In some embodiments, the counselor 44 can make a test subject data entry at step 10 to reflect whether a scheduled counseling was attended or not. These can result in the aforementioned conspicuous indicia being associated with a test subject for monitoring lists or monitoring reports.

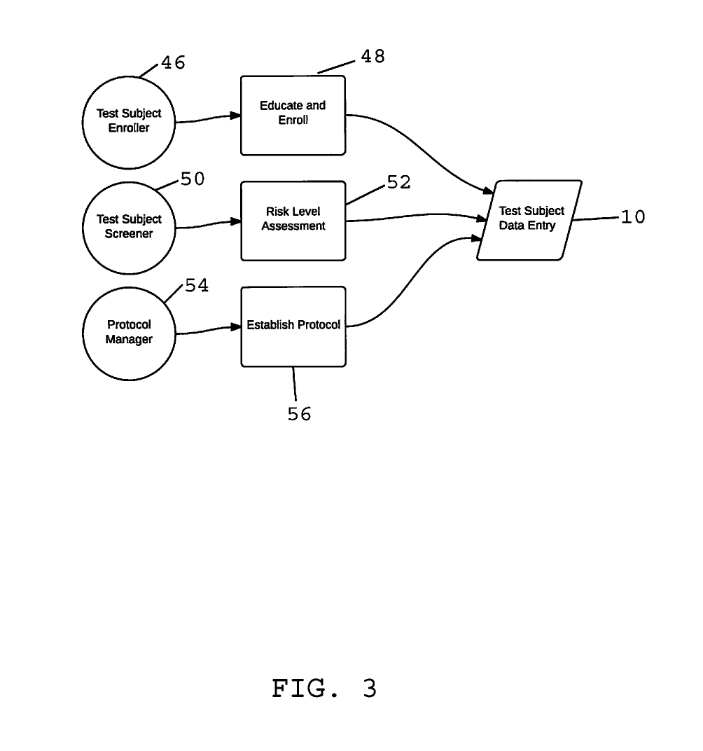

With reference to FIG. 3, in some embodiments in the invention, a test subject enroller 46 performs the step of enrolling test subjects and educating test subjects on the method for monitoring use of controlled substances in accordance with this invention. This is shown at the educate and enroll step 48. This step can also include obtaining the consent of the test subject to submit to the present method. Thus, in some embodiments, the method further includes obtaining consent of the test subject to accept and abide by the scheduling of random dates in said step of scheduling and submit to the drug test or drug usage monitoring when advised in the advice of test details step 26. For example, the test subject agrees to abide by the rules set forth in this method, including the consequences established set forth for test failures, unsuccessful contacts and failed attendance as described above. The actual consequences of failure will be left to those implementing the present method. A physician or prescriber will typically be the only individual that can modify a treatment plan based on results. As shown, the test subject enroller 46 may enter data regarding the education and enrollment at the test subject data entry step 10. SUCH LIABILITY CONCEPTS YOU INDICATE ARE APPRECIATED. THE BROAD STATEMENT THAT CONSEQUENCES ARE LEFT TO OTHER SHOULD BE SUFFICIENT.

In other embodiments, a test subject screener 50 performs the step of screening test subjects and identifying a risk level of substance abuse for each test subject screened. This is shown at the risk level assessment step 52. As shown, the test subject screener 50 may enter data regarding the risk level assessment in the test subject data entry step 10.

In other embodiments, a protocol manager 54 performs the step of establishing a protocol for test subjects, the protocol being entered into the monitoring program 12 to control the type or types of tests scheduled in the step of scheduling and thereby also establishing the type of types of tests performed in said step of performing and for which results are recorded and associated in the steps of recording the test results entry 34 and associating the test results entry. This is shown at the established protocol step 56, as shown the protocol manager 54 may enter data regarding the protocol established at the test subject data entry step 10.

In some embodiments, the results overseer 42, the test subject enroller 46, the test subject screener 50 and the protocol manager 54 are a single individual. In other embodiments, one or more individuals perform these rules.

In some embodiments wherein a physician receives or accesses monitoring reports, the method further includes the step of the physician maintaining or discontinuing the prescription for a given test subject based at least in part on the monitoring report. In some embodiments, a prescription is maintained in the step of the physician maintaining or discontinuing the prescription and the monitoring program is therefore cause to repeat the steps date, attempting to contact the test subject and advising the test subject as to the random date.

In some embodiments, the physician 40, results overseer 42, counselor 44 and protocol manager 54 work together and communicate to establish further protocols to be entered at the test subject data entry step 10. It would be appreciated that the present method, when repeatedly employed, allows for a tailoring of testing protocol based on risk level assessments and past test performance. It provides those that prescribe controlled substances a method by which to monitor potential abuse. By taking these steps to monitor potential abuse, those that prescribe controlled substance can show due diligence in seeking to prevent drug abuse by their test subjects. This may insulate them from charges of negligence in the prescribing of controlled substances and monitoring their use. More importantly, it will serve to prevent drug abuse by test subjects.

After working with a test subject through this method for at least one drug test or one drug usage test, risk level assessments can be altered and changed at the test subject data entry step 10 for a subsequent practice of this method. In some embodiments, the risk level assessment is done initially (before enrollment) and periodically thereafter. In some embodiments, the risk level assessment is monthly.

In light of the foregoing, it should be appreciated that the present invention significantly advances the art by providing a method for monitoring the use of controlled substances that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A computer implemented method for monitoring use of controlled substances by one or more test subjects comprising the steps of:
entering contact data for a test subject into a monitoring program, the monitoring program interacting with appropriate communication hardware such that the monitoring program is able to contact the test subject through the communication hardware using the contact data; after said step of entering, the monitoring program thereafter executing the step of:
scheduling a random date for a drug test or drug usage test or both for the test subject; the monitoring program thereafter executing the step of attempting to contact the test subject through the communication hardware using the contact data and, if successful contact is made, executing the step of
advising the test subject as to the random date the test subject is required to submit to a drug test or a drug usage test or both relating to the use of a controlled substance, and, if successful contact is not made, executing the step of
recording a failed contact entry and associating the failed contact entry with the test subject.

2. The method of claim 1, wherein the controlled substance is selected from opiates, amphetamines, marijuana, cocaine, phencyclidine (PCP), cannabinoids, barbiturates, hydrocodones, methaqualones and benzodiazepines.

3. The method of claim 1, wherein the controlled substance is selected from opiates, sedatives, hypnotics and stimulants.

4. The method of claim 1, wherein, if successful contact is made in said step of attempting to contact the test subject, the monitoring program thereafter executes the step of:
recording a successful contact entry and associating it with the test subject.

5. The method of claim 4, wherein, if successful contact is made in said step of attempting to contact the test subject, the monitoring program generates a test results date for monitoring the results of the test scheduled in said step of scheduling.

6. The method of claim 4, wherein a failed contact entry results from the monitoring program receiving notice of an event selected from a disconnected phone, an invalid number and a blocked call.

7. The method of claim 1, further comprising the step of recording a failed attendance entry in the monitoring program and associating it with the test subject if the test subject does not show at the test scheduled in said step of scheduling.

8. The method of claim 1, further comprising the step of:
performing the drug test or drug usage test or both on the test subject on the random date; and
recording a test results entry in the monitoring program and associating the test results entry with the test subject.

9. The method of claim 8, wherein said step of performing is performed by testing software or testing hardware or both, and said step of recording a test results entry is performed automatically by the testing software or testing software or both communicating with the monitoring software.

10. The method of claim 8, wherein the monitoring program further performs the step of generating a monitoring report providing compliance data associated with the test subject, the compliance data being selected from one or more of the failed contact entry, successful contact entry, failed attendance entry, and test results entry.

11. The method of claim 8, wherein the monitoring software monitors multiple test subjects through said steps of entering contact data, scheduling a random date, attempting to contact, advising the test subject and recording the test results entry.

12. The method of claim 11, wherein the monitoring program further performs the step of generating a results list providing compliance data associated with the test subject, the compliance data being selected from one or more of the failed contact entry, successful contact entry, failed attendance entry, and test results entry, and the results list is accessible to quickly show the compliance data.

13. The method of claim 12, wherein the results list can be accessed via computer, the results list displayed on a monitor of the computer.

14. The method of claim 13, wherein the results list provides conspicuous indicia indicating the compliance data.

15. The method of claim 14, wherein the conspicuous indicia is a red flag if the compliance data includes one or more of a failed contact entry, a failed attendance entry or a test results entry indicated failure of a test.

16. The method of claim 12, further comprising the steps of:
establishing a results overseer that is provided with access to the results list, wherein the results overseer identifies at-risk test subjects based on results of drug tests or drug usage tests.

17. The method of claim 16, wherein the results overseer directly or indirectly refers at-risk test subjects to counseling

18. The method of claim 16, further comprising the steps of:
establishing a protocol manager that performs the step of establishing a protocol for test subjects, the protocol being entered into said monitoring program to control the type or types of tests scheduled in said step of scheduling and thus also establishing the type or types of tests performed in said step of performing and for which results are recorded and associated in said steps of recording a test results entry and associating the test results entry.

19. The method of claim 11, wherein the monitoring software through associated hardware further performs the step of generating a monitoring report providing compliance data associated with the test subject, the compliance data being selected from one or more of the failed contact entry, successful contact entry, failed attendance entry, and test results entry, wherein test subjects are prescribed a prescription for controlled substances by a physician, the physician receiving the monitoring reports from said step of generating a monitoring report.

20. The method of claim 19, further comprising the step of the physician maintaining or discontinuing the prescription for a given test subject based at least in part on the monitoring report.
